(19) United States
(12) Patent Application Publication
(10) Pub. No.: US 2011/0125525 A1
(43) Pub. Date: May 26, 2011

(54) METHOD OF ANTICIPATING AN EPIDEMIC IN A POPULATION, AND A SYSTEM THEREOF

(75) Inventors: Ka Kui Francois LUNG, Hong Kong (HK); Wai Choi TANG, Hong Kong (HK); Ka Yin Ken LEE, Hong Kong (HK)

(73) Assignee: LX1 TECHNOLOGY LTD., Hong Kong (HK)

(21) Appl. No.: 12/623,339

(22) Filed: Nov. 20, 2009

(51) Int. Cl. G06Q 50/00; G06Q 10/00; G06N 5/02

(52) U.S. Cl. 705/3; 705/2; 706/52

(57) ABSTRACT

A monitoring system is described comprising client computers 103 distributed in different location and a host computer 101. The system is capable of recording clinical symptoms of patients recorded via the client computers 103, and compiling the clinical symptoms to note any sudden increase of clinical symptom or specific combination of clinical symptoms. Thus, a trend may be observed before diagnosis and statistics can confirm infection outbreak allowing doctors to anticipate an infection outbreak, or epidemic.

### FIELD OF INVENTION

The invention relates to a system and method for detecting an increase in clinical symptoms in a population. More particularly, the invention relates to anticipating the spread of a disease or an infection outbreak.

### BACKGROUND OF THE INVENTION

When a patient sees a doctor in private clinic for a condition which has clinical symptoms that are commonly seen in many illnesses, such as fever and aches, the doctor is usually none the wiser whether the patient marks the beginning of the outbreak of a particularly infectious disease which could lead to an epidemic.

In order to confirm that an epidemic has broken out, a diagnosis of the patient's condition is necessary. Subsequently, it is also necessary to observe if there is a sudden increase in the number of patients diagnosed with the same disease or infection.

Usually, this means that many patients must have been admitted to hospitals and their conditions diagnosed and confirmed. Furthermore, laboratory tests have to be completed to identify the infection agent and to establish how easily can the infection spread. Furthermore, statistics need to be compiled, because an outbreak is sometimes identified only when a large enough number of people in a population is infected.

This process usually takes time and, if the disease it not particularly deadly, could be overlooked until the number of infected people has escalated alarmingly.

Thus, doctors are informed about an infection only after the epidemic has broken out. Without confirmed diagnosis, it is hard for the medical authorities to trend an infection. Thus, there is a risk that some patients might have been misdiagnosed of the infection and be sent home without warning to the contagiousness of their condition.

Thus, it is desirable to provide a way to improve the monitoring and anticipation of an infection outbreak, or an epidemic.

### SUMMARY OF THE INVENTION

In a first aspect, the invention provides a system for anticipating an epidemic, comprising a host computer, a plurality client computers having an interface for users to record clinical symptoms of patients, the plurality of client computers having a communication link to the host computer, the plurality of client computers each containing a set of rules, the set of rules indicating at least one clinical symptom, when the clinical symptoms of a patient is recorded into one of the plurality of client computers, the one of the plurality of client computers compares the clinical symptoms of the patient with the at least one clinical symptom in the set of rules, if clinical symptom of the patient matches the at least one clinical symptom in the set of rules, data on the condition of patient is sent to the host computer, wherein the host computer compiles the data on the condition of patients from the plurality of client computers.

In a second aspect, the invention provides a system for anticipating an epidemic, comprising a host computer, a plurality client computers having an interface for users to record clinical symptoms of patients, the plurality of client computers having a communication link to the host computer to upload the records of clinical symptoms of patients to the host computer, the host computer storing a predetermined threshold value, the host computer having capability for identifying at least one of the clinical symptoms with an occurrence above the threshold value, the host computer having a communication link to the client computers for triggering an alert in the client computers to the at least one clinical symptoms with an occurrence above the threshold value.

Optionally, the threshold value is an alert-frequency whereby, if the frequency of the occurrence of the symptom exceeds the alert frequency, an alert could be raised that there are suddenly too many patients with the symptom. Optionally, the threshold value is a percentage based on historical data. Optionally, the threshold value is a pre-determined rate of increase of the frequency of occurrence.

In a third aspect, the invention provides a method of anticipating an epidemic, comprising the steps of recording clinical symptoms of patients at interface provided in a plurality of client computers, uploading the records of clinical symptoms of patients to a host computer, compiling the records of clinical symptoms of patients to the host computer, identifying at least one clinical symptom from among the records of clinical symptoms that have a number of occurrences over a pre-determined threshold, triggering an alert in the client computers to the at least one clinical symptom.

Therefore, the invention provides the possibility of anticipating an infection outbreak or an epidemic before health authorities are able to confirm the infection outbreak by laboratory tests, statistics and compilation of confirmed diagnoses. In other words, the invention provides the possibility of monitoring the clinical symptoms of patients across a region or a country and identifies any significant increase in the occurrences of clinical symptoms. Thus, an alert may be raised to doctors a possible infection outbreak before an outbreak is confirmed. Accordingly, there is no need to rely on the slow submission and compilation of diagnoses and laboratory tests before doctors are placed on guard.

In other words, the invention also provides the possibility of alerting a doctor that his patient has clinical symptoms which are seen in many other patients recently. Thus, the doctor may thereby be alerted to be particularly careful to treat the patient as possibly infectious. In this way, the doctors can also begin to look out for other patients exhibiting the same clinical symptoms in advance of the confirmation of the infection outbreak.

Furthermore, the invention provides a possibility that patient data can be accumulated and compiled from the records of plurality of doctors within a region, virtually in real time. This drastically reduced the time required to compile information to identify an infection outbreak, or to track the direction of the spread of the infection.

Preferably, patients are monitored for specific combinations of clinical symptoms, instead of individual clinical symptoms. This is because many diseases are characterised by specific combination of clinical symptoms, allowing one disease to be distinguished from another.

Furthermore, the invention provides the possibility of tracking the spread of specific infection and to map the direction of the spread geographically.

### BRIEF DESCRIPTION OF THE FIGURES

It will be convenient to further describe the present invention with respect to the accompanying drawings that illustrate possible arrangements of the invention, in which like reference numbers refer to like parts. Other arrangements of the invention are possible, and consequently the particularity of the accompanying drawings is not to be understood as superseding the generality of the preceding description of the invention, wherein

FIG. 1 illustrates a first embodiment of the invention;

FIG. 2 illustrates an interface used in the embodiment of FIG. 1;

FIG. 3 is another illustration of the interface in the embodiment of FIG. 1;

FIG. 4 illustrates how clinical symptoms are monitored by a second embodiment;

FIG. 4a illustrates an alert message used in how clinical symptoms are monitored by the second embodiment;

FIG. 5 illustrates an alternative to how clinical symptoms are monitored by the second embodiment;

FIG. 6 illustrates a possible flowchart for the second embodiment; and

FIG. 7 illustrates a flowchart complementary to the flow chart of FIG. 6 for the second embodiment.

### DETAILED DESCRIPTION OF THE INVENTION

Embodiments of the invention will now be described, wherein the embodiments comprise a surveillance system 100 for anticipating the outbreak of a disease, such as an infection.

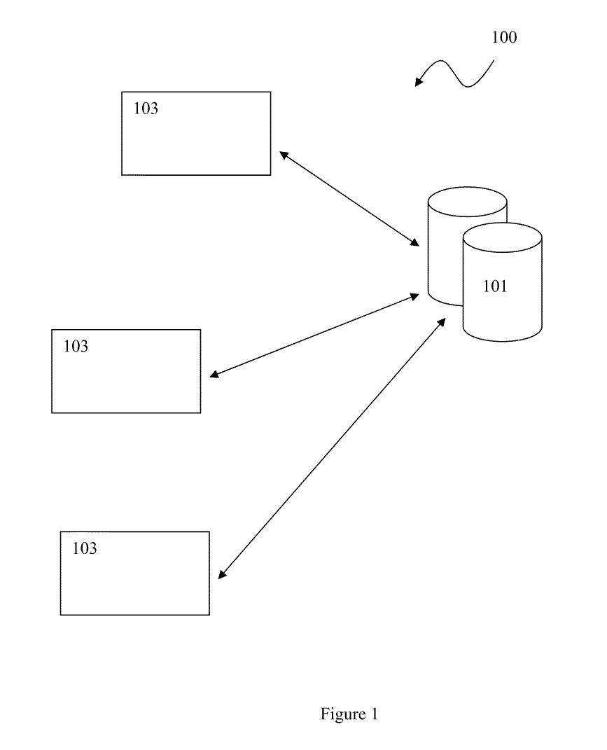

FIG. 1 is illustrates the first embodiment 100 as comprising a host computer 101 and a plurality of client computers 103. The host computer 101 is in communication with the plurality of client computers 103. The host computer 101 is preferably a sever containing a database and the clinical symptoms of the patient is recorded into the database. The client computers 103 are placed in clinics in different locations and preferably spread out across a country or geographical region.

A set of ‘rules’ identify symptoms of a possibly infectious disease is established and set by the medical authorities, stored in the host computer 101. The rules contain a list of clinical symptoms to be checked for with each new patient, which could suggest whether the patient is infected with an infection agent suspected to be capable of causing an epidemic.

In this first embodiment, the client computers 103 are programmed to occasionally poll the host computer 101 to download the latest set of rules. When a set of rules is downloaded, the rules are stored within the client computer 103.

When a patient visits a clinic to see a doctor, the doctor notes the clinical symptoms of the patient and enters his observations of the patient's clinical symptoms into a client computer 103 in the clinic. The client computer 103 then compares the patient's clinical symptoms with those clinical symptoms listed in the rules. If the patient's clinical symptoms match the clinical symptoms listed in the rules, the client computer 103 sends the patient's data to the host computer 101. Furthermore, the client computer 103 triggers a pop-up informing the doctor that the patient's symptoms match those in the rules and that the patient may therefore be carrying a contagious infection. In this way, the host computer 101 is able to receive and compile patients' clinical symptoms, and count the number of patients who exhibit the clinical symptoms listed in the rules. Accordingly, the host computer 101 is able to provide data on how many people show the same symptoms. The medical authorities can then decide based on the data if there is a possible infection outbreak and get their resources placed on standby in anticipation of the infection outbreak. This is before analyses or tests on patient samples (such as microbial, blood, stool, and phlegm etc.) can be completed, and before there is sufficient number of patients with confirmed diagnosis that can be compiled statistically.

The embodiment therefore provides an early alert to the doctors and medical authorities of a possible though unconfirmed infection outbreak, and also the possibility of tracing patients possibly infected with the infection after the outbreak has been confirmed.

Although, the clinical symptoms listed in the rules are established by medical authorities, the clinical symptoms are not necessarily indicative of a confirmed infection. The rules by themselves do not diagnose or help diagnose the patient's condition. The rules only help to identify people with a specific set of clinical symptoms.

Preferably, the host computer 101 records the address of the patient and maps the direction of spread of the symptoms (not illustrated). Furthermore, the host computer 101 records the time when the patient saw the doctor. When it is confirmed that there is an infection outbreak, this could help to back track how quickly is the infection spreading.

An example of the rules, having three clinical symptoms to look out for, is shown below:

1) Fever >38° C.

2) Rashes

3) Aversion to light

It is possible that more than one set of rules can be stored in the client computers 103 at any one time. This addresses the possibility of a simultaneous outbreak of two infection agents leading to different symptoms.

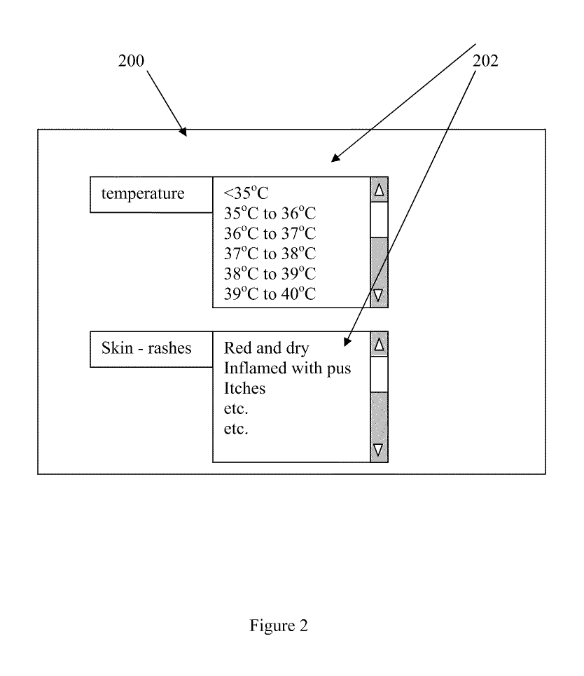

FIG. 2 shows an illustration of a possible graphical user interface 200, on the screen of a client computer 103, by which the doctor can record the clinical symptoms seen in a patient. Examples of the clinical symptoms illustrated in FIG. 2 include fever at several specific ranges of temperature, and rashes having specific features, and so on. The illustrated graphical user interface 200 shows a drop-down list 202 of body temperature, which the doctor can select from.

The graphical user interface 200 also show a second dropdown list 202, listing the options that may be selected to correctly describe the types of rashes a patient has.

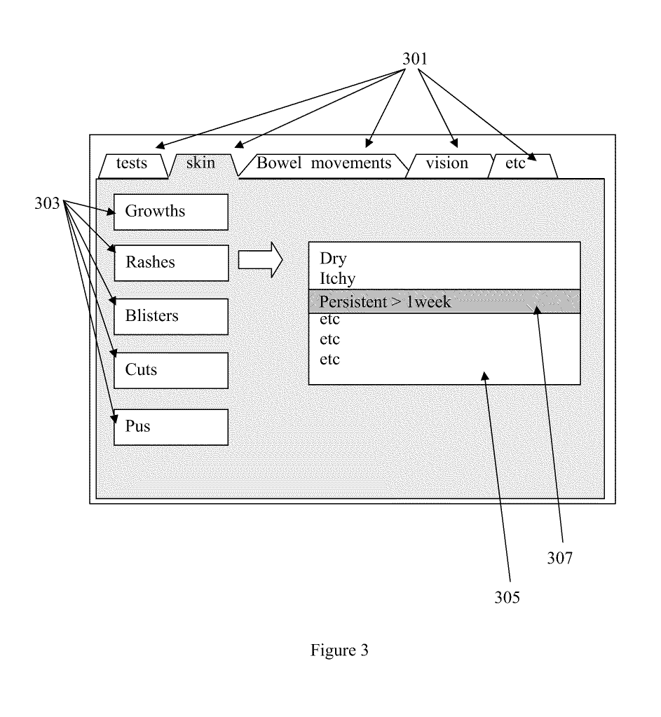

The drop down list 202 in the graphical interface 200 is preferably designed to be in a drill-down format. FIG. 3 illustrates this, showing a graphical user interface 200 where different body part or function are presented as selectable tabs 301, i.e. skin, bowel movements, vision, tests (possibly blood test) etc. The doctor can simply select each tab 301 to record his observations for that body part or category of observation.

Under each tab 301 is further sub-classification 303 of possible observations or clinical symptoms which the doctor can select from. FIG. 3 illustrates that possible clinical symptoms 303 that may be seen on the skin can include growths, rashes, blisters cuts and pus.

Under each classification of clinical symptom 303 there can be sub-classifications 305. For example, FIG. 3 shows how rashes can be further sub-classified as dry, itchy or persistent and so on. These choices 305 are not mutually exclusive and more than one selection may be made. FIG. 3 illustrates how a rash which has been persistent for more than 1 week has been selected.

Advantageously, the sub-classifications 305 of the clinical symptoms 303 guide the doctor in making his clinical observations, as it serves as a check list to note clinical symptoms in an orderly manner.

Optionally, to make the system 100 easier to use, it is possible that only clinical symptoms that are possibly found in any infection are included in the sub-classifications. Symptoms or other health problems which are not generally related to infections are omitted, such as impact injuries and bone factures.

The graphical user interface 200 can be a written as an executable program to be installed onto each client computer 103 or it can be implemented as a browser launched interface using web-based technologies such as HTML and ASPx etc. The extent of the technologies useable is known and need not be elaborated on here.

In a second embodiment, the host computer 101 is able to note that there is a possible infection outbreak automatically.

When a patient visits a clinic to see a doctor, the doctor notes the clinical symptoms of the patient and enters his observations of the clinical symptoms seen in patient into a client computer 103 in the clinic. The client computer 103 then uploads the observation into the database in the host computer 101. Typically, information on the clinical symptoms seen in a plurality of patients is uploaded from different client computers 103 in various locations within the country.

The host computer 101 then compiles the clinical symptoms uploaded from all the client computers 103 so that the frequency of occurrence of each clinical symptom can be calculated. The frequency of occurrence of each clinical symptom can be obtained for different interval periods, such as an hour, a couple of hours, a day, 3 days or as long as a week, a month, or even a year or longer. For example, it may be detected that the occurrence of fever on a particular day is one hundred cases, among all the clinics using the system 100.

The host computer 101 contains an ‘alert-frequency’ for each clinical symptom, which is pre-determined and set by the medical authorities. When the occurrence of a particular clinical symptom exceeds its ‘alert-frequency’, it shows that an unusually high occurrence of the clinical symptom is detected in the population. This suggests that there could be an infection outbreak which causes the clinical symptom in a patient. The host computer 101 then raises an alert to all the client computers 103 about the clinical symptom. The client computers 103 then display the alert notifying the doctor about the clinical symptom. Typically, the alert-frequency is established through historical records of infection outbreaks.

Thus, in this embodiment, the medical authorities need not manually study the data collected in the host computer 101 to decide if there is a possible infection outbreak.

Preferably, a different alert-frequency is set for different clinical symptoms. This is because some clinical symptoms are more common than other clinical symptoms when there is no infection outbreak. For example, the alert-frequency for running nose can be set at one hundred cases per day, while the alert-frequency for massive internal bleeding can be set at one case per day. In other words, there is a greater tolerance for running noses than internal bleeding.

Furthermore, different alert frequencies can be set for different intervals of time, even for the same clinical symptom. For example, the alert-frequency for fever can be set at one hundred cases per day and also at fifty cases per week. This helps to detect and monitor different types of infections having different rate of spreading.

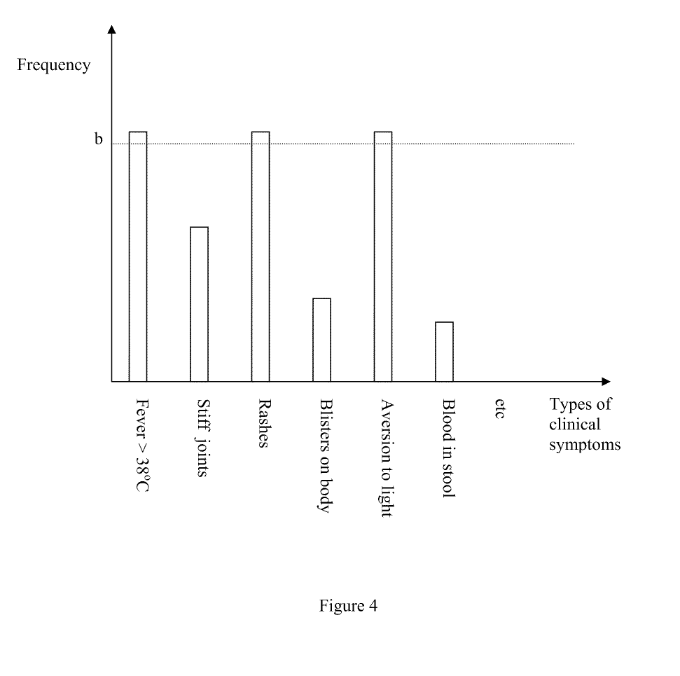

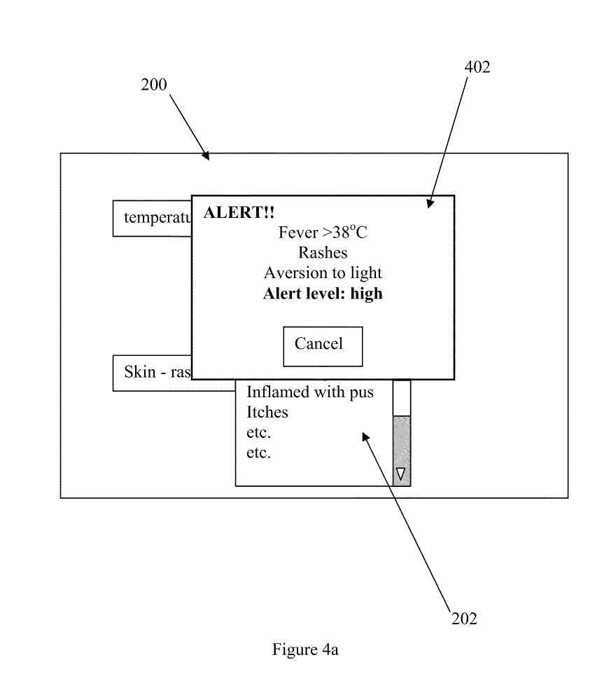

FIG. 4 shows a bar chart, in which the bars indicate the frequency of occurrence of certain clinical symptoms. Frequency b illustrated in FIG. 4 is the aforementioned alert-frequency. While it is described that there could be different alert-frequency for different clinical symptoms, FIG. 4 assumes that all the clinical symptoms share the same alert-frequency b for the sake of simplicity.

FIG. 4 shows that the occurrence of fever above 38° C. exceeds frequency b. Similarly, the separate clinical symptoms of rashes and aversion to light also exceed frequency b. Thus, an alert is sent to all client computers 103 to inform doctors to look out for patients having of these clinical symptoms.

FIG. 4a illustrates an example of a pop-up message 402 that appears on the screen of a client computer 103, which is the alert issued by the host computer 101. The pop-up message identifies the clinical symptom, and alerts the doctor to pay particular attention to patients with this clinical symptom. Optionally, an email or SMS can also be sent to the doctor by the host computer 101. Thus, even if the doctor is away from the clinic, he may be alerted to the clinical symptom. This is advantageous for a doctor who usually pays home visit and is not stationed in his clinic.

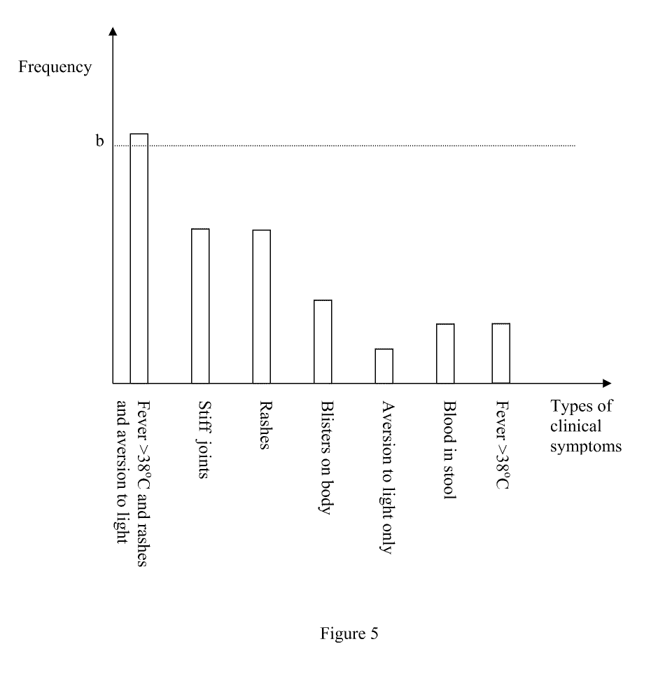

FIG. 4 shows that when the clinical symptoms of fever >38° C., rashes and aversion to light are monitored separately, these clinical symptoms each exceeds the alert-frequency b. However, if clinical symptoms are monitored in combinations, FIG. 4 could look very different. This is illustrated in FIG. 5.

FIG. 5 illustrates an alternative way in which data on patient clinical symptoms can be compiled by the host computer 101, wherein clinical symptoms are monitored in combinations instead of as separate individual clinical symptoms. The combinations are based on several clinical symptoms seen in any single patient. This is because many diseases are characterised by and are to be distinguished by more than one clinical symptom. Thus, it is more expedient to compile all the clinical symptoms seen in a patient and look for clinical symptoms in a similar combination in other patients. More specifically, FIG. 5 shows that the frequency of occurrence of patients having only a single clinical symptom of aversion to light, without the accompanying clinical symptoms of fever and rashes, is below the alert-frequency b. This is also the same for the individual clinical symptom of fever and the individual clinical symptom of rashes. However, the frequency of occurrence of all three clinical symptoms in any single patient remains high, above frequency b. This means that there are many cases of patients having all three clinical symptoms of fever >38° C., rashes and aversion to light. Thus, the host computer 101 sends an alert to each client computer 103 to notify the doctors to be particularly careful to note this combination of clinical symptoms in their patients, in anticipation of an infection outbreak causing these clinical symptoms.

Furthermore, going back to FIG. 4, if clinical symptoms are monitored individually and not in combinations, the number of patients having only rashes is very high (patients A, B, C and E). However, the high incident of rashes can be explained as a common clinical symptom of several types of diseases. This shows that monitoring the clinical symptoms in combinations allows one to identify such false alarms based on a single clinical symptom.

On the other hand, because many infections share one or two common clinical symptoms, a high incidence of a particular clinical symptom within a period of time does not always mean that there is an outbreak of an infection giving that clinical symptom. Instead, a high frequency of occurrence of a single clinical symptom could also be due to a moderate increase in several unrelated illnesses, all of which could cause that clinical symptom, but the moderate increase of these illnesses does not amount to an outbreak of a single infection. Thus, by monitoring clinical symptoms in combinations, false alarms of a virulent infection outbreak which is due to a common clinical symptom caused by several unrelated diseases can be avoided. An example of a common clinical symptom caused by many illnesses and infections is fever. Unless accompanied by other clinical symptoms such as rashes, blisters, running noses, aches in the body and so on, a sudden high occurrence of fever in the population alone does not always imply an infection outbreak of a single disease.

Table I illustrates further how the data of the second embodiment can be mined.

TABLE I

| | Symptoms | | | | |
|---|---|---|---|---|---|
| | Fever > | | Aversion to | | |
| Patient | 38 C. | Rashes | light | Diarrhoea | Cough |
| A | Yes | Yes | Yes | Yes | Yes |
| B | Yes | Yes | Yes | No | No |
| C | No | Yes | Yes | No | No |
| D | No | No | No | Yes | No |
| E | No | Yes | No | No | Yes |

For the sake of conciseness, it is assumed that the table shows a high number of patients with fever >38° C., rashes and aversion to light (for example, both patients A and B).

Accordingly, the host computer 101 sends an alert to each client computer 103, indicating to the doctor to look out for patients having a combination of having all three clinical symptoms of fever >38° C., rashes and aversion to light.

The clinical symptom of diarrhoea in patient A is not found in patient B and C, and this clinical symptom could be dismissed as a coincidental occurrence. Thus, the doctor should not be alerted to anticipate an infection giving diarrhoea. However, this does not mean that patients with diarrhoea should be disregarded as possibly having been infected with same infection. Instead, it means that any patient having the combination of clinical symptoms of the alert, with or without diarrhoea, should be monitored as a possible carrier of an anticipated infection.

Thus, despite the extra clinical symptoms of cough and diarrhoea in patient A, all patients A, B and C are identified together as having common clinical symptoms of fever >38° C., rashes and aversion to light, and possibly having the same infection. This helps to prevent overlooking patient A as a possible carrier of the infection simply because he has extra clinical symptoms to those in the alert, which could be a co-incidental clinical symptom.

Furthermore, the table shows an even higher number of patients with only rashes and aversion to light (patients A, B and C). Thus, a second alert is also sent to each client computer 103 to notify the doctor to look out for patients having the clinical symptom combination of rashes and aversion to light. As the number of cases reported with only these two clinical symptoms is higher than the number of cases with all three clinical symptoms of fever >38° C., rashes and aversion to light, this second alert is of a higher priority than the first alert.

Priority of the alerts can be set in many ways, as the skilled man knows. For example, the host computer 101 may be programmed to set to a higher priority any alert which relate to a very serious clinical symptom. For example, any alert which indicates massive internal bleeding is set to a higher priority than another alert that does not indicate massive internal bleeding.

Preferably, an indication can be shown on the client computer 103 screen indicating the level of priority, such as ‘extremely high’, ‘high’, ‘moderate’ etc (not illustrated). Preferably, there is no low priority as an alert always require urgent attention. Alternatively, numerical indication is used to indicate the priority, such as level 1 to 10 to indicate low to high priority.

Although Table 1 shows that there two patients with diarrhoea (patients A and D), which is the same number as patients having fever >38° C., rashes and aversion to light, an alert is not issued to the client computers 103 to anticipate an epidemic causing diarrhoea. This is because diarrhoea is very common among the population from many different causes. Thus, a greater frequency of occurrence is required to raise an alert for diarrhoea.

Alternatively, instead of triggering an alert based on frequency of occurrence, an alert is triggered based on the percentage increase in the number occurrence of a clinical symptom, over a typical baseline. This allows the system 100 to address seasonal changes. For example, an alert could be set to be triggered when the number of common cold cases increase by 30%. If, when there is no epidemic, it is typical to have about one hundred occurrences per day of common cold during summer, it takes one hundred and thirty cases per day to raise an alert. Furthermore, if it is typical to see about two hundred occurrences per day of common cold during winter when there is no epidemic, it takes two hundred and sixty cases per day to raise an alert during winter. Accordingly, monitoring a clinical symptom by percentage over on historical data allows the system 100 to prevent false alarms from being raised due to seasonal fluctuations.

Alternatively, an alert is triggered based on the ‘rate’ of increase of occurrence of a clinical symptom, against the number of occurrences recorded for the day before. This is illustrated using the Table II below.

TABLE II

| | Day 1 | Day 2 | Day 3 | Day 4 |
|---|---|---|---|---|
| Number of | 60 | 80 | 120 | 180 |
| cases | | | | |
| Rate of | N.A. | 33.3% | 50% | 50% |
| increase | | | | |

Table II shows that on a first day, and the system 100 records only sixty occurrences of, for example, fever. On the second day, the system 100 records eighty new occurrences. On the third day, the system 100 records one hundred and twenty new cases. If the alert-frequency b according to the embodiment of FIG. 4 is set at one hundred and thirty occurrences a day, no alert would be triggered for any of the first three days. Only the fourth day sees a number of occurrences of the symptom that is high enough to raise an alert.

However, if an alert may be triggered based on a >=30% ‘rate of increase’ over the number of occurrences recorded in the previous day, then an alert will be issued on the second day, since the second day see 33% more cases than the first day. Similarly, the third day sees 50% more cases than the second day, and the fourth day sees 50% more cases than the third day. Thus, an alert is also raised for the third and fourth days.

Thus, any sudden increase in the number of occurrence could raise an alert without regard to the actual number of occurrences.

The skilled man knows that the rate of increase in the occurrence of symptoms may be monitored in units of days, weeks or months.

Optionally, as soon as the alert is issued to the client computers 103, the client computers 103 also poll the host computer 101 to download the latest rules, as in the first embodiment. The clinical symptoms of the next patient whom the doctor sees can be quickly checked against the rules by the client computer, so that an alert can be issued by the client computer 103 to the doctor, indicating that the patient's clinical symptoms matches those in the rules. Data on the patent's conditions is then sent to the host computer 101, as described before.

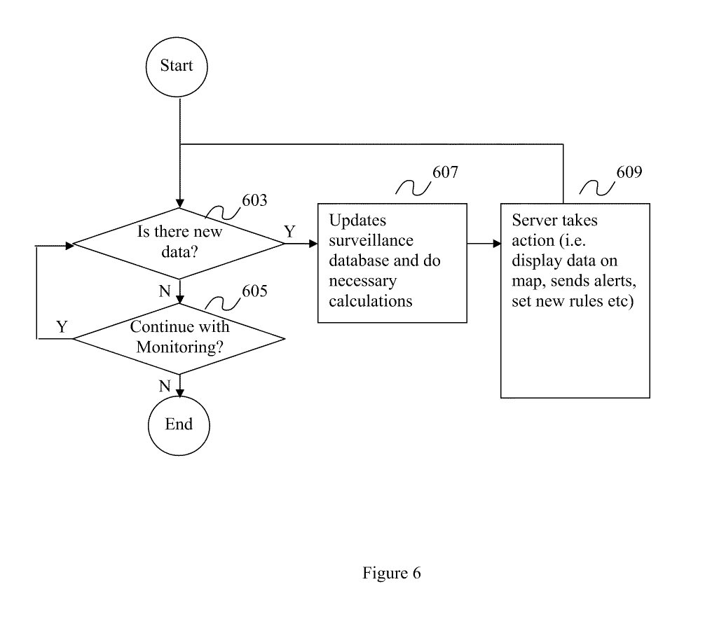

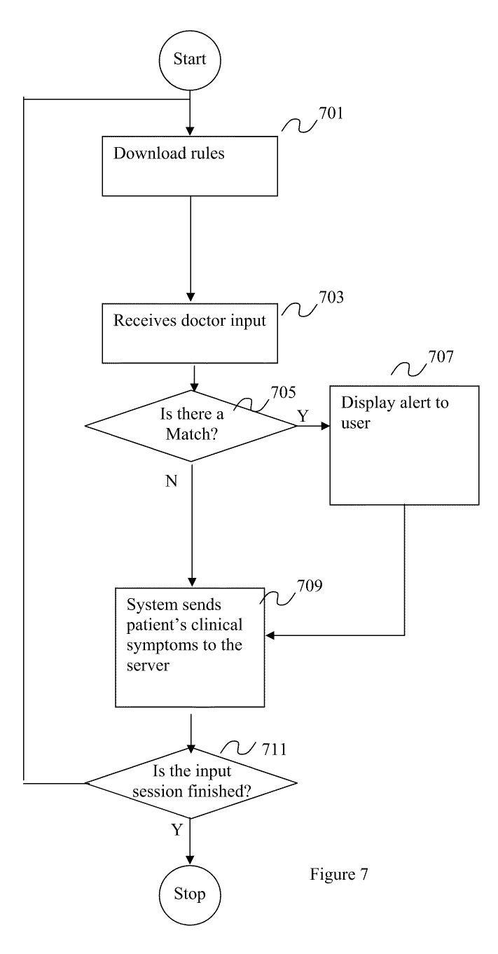

FIG. 6 illustrates a flowchart of the second embodiment, which is one possible example of the steps taken by the host computer 101. A corresponding flowchart indicating the steps taken by the client computers 103 are shown in FIG. 7.

In FIG. 6, when the host computer's 101 surveillance function is started, the host computer 101 begins to listen for, or monitor for, incoming data from the client computers 103. For example, the host computer 101 periodically checks for new data from any of the client computers 103, at step 603. Any record of a patient's conditions and his clinical symptoms made in a client computer 103 is sent to the host computer 101.

Thus, if there is no data sent from any of the client computers 103, the surveillance function of the host computer 101 loops to continually monitor incoming data. However, if a doctor enters a patient's clinical symptom into a client computer 103 and sends the data to the host computer 101, the host computer 101 receives the data and updates the database in the host computer 101, step 607. The host computer 101 then makes compilations in the database to calculate the frequency of occurrence of the clinical symptoms in the patients. As discussed in the foregoing examples, the frequency of occurrence can be calculated for each individual clinical symptom and also for the combination of clinical symptoms seen in the patient. Preferably, the frequency of occurrence is also calculated for different sub-sets of all the combinations of clinical symptoms seen in patients, as discussed for Table I. If any of the clinical symptom, combination of clinical symptoms, or sub-sets of the combinations of the clinical symptoms has a frequency of occurrence greater than their respective pre-determined alert-frequency, the host computer 101 sends an alert to the client computers 103, at step 609, and issues a new set of rules for the clinical symptom, combination of clinical symptoms, or sub-sets of the combinations of the clinical symptoms if required. Thus, the doctor is alerted to the growing number of patients with particular clinical symptoms to anticipate a possible infection outbreak. The system 100 then resumes monitoring for new data from other client computers 103, at step 603.

Turning now to FIG. 7, the client computers 103 are shown to have two types of input. The first being alerts and rules sent from the host computer 101 to the client computers 103 and the second being data entered by the doctors into the client computers 103.

As the client computer 103 receives input from the doctor recording a patient's clinical symptoms, at step 703, the client computer 103 compares the patient's clinical symptoms to the clinical symptoms listed in the rules, at step 705. If the clinical symptoms of a patient match the clinical symptoms listed in the rules, the client computer 103 displays an alert that the patient could be carrying a common infection, at step 707, and notifies the host computer 101.

Whether the patient's clinical symptoms matches the clinical symptoms in the rules or not, the client computer 103 send the patients clinical symptoms to the host computer 101, at step 709, so that the patient's clinical symptoms can be included into the existing data in the host computer 101. Unless the routine is shutdown, the flow loops continually, from step 711.

Therefore, the described embodiments 100 include a system 100 for anticipating an epidemic in a population, comprising a host computer 101, a plurality client computers 103 having an interface for users to record clinical symptoms of patients, the plurality of client computers 103 having a communication link to the host computer 101, the plurality of client computers 103 each containing a set of rules, the set of rules indicating at least one clinical symptom, when the clinical symptoms of a patient is recorded into one of the plurality of client computers 103, the one of the plurality of client computers 103 compares the clinical symptoms of the patient with the at least one clinical symptom in the set of rules, if clinical symptom of the patient matches the at least one clinical symptom in the set of rules, data on the condition of patient is sent to the host computer 101, wherein the host computer 101 compiles the data on the condition of patients from the plurality of client computers 103.

Therefore, the described embodiments 100 include a system 100 for detecting an increase in clinical symptoms in a population, comprising a host computer 101, a plurality client computers 103 having an interface for users to record clinical symptoms of patients, the plurality of client computers 103 having a communication link to the host computer 101 to upload the records of clinical symptoms of patients to the host computer 101, the host computer 101 storing a predetermined threshold value, the host computer 101 having capability for identifying at least one of the clinical symptoms with an occurrence above the threshold value, the host computer 101 having a communication link to the client computers 103 for triggering an alert in the client computers 103 to the at least one clinical symptoms with an occurrence above the threshold value.

Therefore, the described embodiments 100 include a method of anticipating an epidemic in a population, comprising the steps of recording clinical symptoms of patients at interface provided in a plurality of client computers 103, uploading the records of clinical symptoms of patients to a host computer 101, compiling the records of clinical symptoms of patients to the host computer 101, identifying at least one clinical symptom from among the records of clinical symptoms that have a number of occurrences over a pre-determined threshold, triggering an alert in the client computers 103 to the at least one clinical symptom.

While there has been described in the foregoing description preferred embodiments of the present invention, it will be understood by those skilled in the technology concerned that many variations or modifications in details of design, construction or operation may be made without departing from the scope of the present invention as claimed.

Preferably, the client computers 103 are located in clinics spread over a wide area. More preferably, the clinics are cross-country clinics. This could trace international spread of an infection.

Preferably, information on the patient's identity is withheld from being uploaded into the host computer 101 to prevent leakage of personal information. If a specific person has to be contacted or quarantined, the clinic which uploaded the person's records can be contacted to trace the person.

In a variation of the embodiment, the client computer 103 also records information about the patient other then clinical observations, such as where he lives or his travel history. The host computer 101 contains information on locations which are prone to certain types of diseases. Thus, where a patient's clinical symptoms can be due to several diseases, the system 100 helps to narrow down the possible diseases to the more likely ones. For example, if a patient has fever and rashes, and the host computer 101 contains information that the residence of the patient is known to have rats infestation, the doctor may be alerted by the system 100 that the patient could have typhus, which is an infection carried by rat fleas. The system 100 thus serves to prevent the doctor from raising a false alarm of an typhus epidemic, by providing an explanation of why the patient is infected with typhus.

It is understood that the skilled man knows that the records of the clinical symptoms may be stored in different forms other than in a database, such as in the form of text files or XML files.

Furthermore, although client computers 103 are mentioned to be in the clinics, it is possible that the client computers 103 are portable devices such as computer notebooks or Personal Digital Assistants (PDA) which doctors can carry with them into the field. This is particularly useful in a condition where health of people who do not live close to health establishments need to be monitored, for example monitoring isolated human tribes for Ebola outbreaks. In this case, the communication between the client computers 103 and the host computer 101 is based on wireless communication with telecommunication service providers or by satellites means.

Advantageously, the embodiment provides the possibility of identifying cases of similar symptoms in a number of patients, across different clinics in a region, and raising an alert to anticipate an infection outbreak.

Advantageously, since observation on a patient's health aspect may also be collected, the embodiment also provides the possibility to monitor a population for an epidemic that is not based on an infectious agent such as a virus. For example, the embodiment provides the possibility to monitor obesity.

Advantageously, the embodiment can be applied to monitoring the fauna of the environment, such as the signs of health or the lack thereof in trapped migratory birds, whales, turtles or endangered species.

Advantageously, it is possible to provide the compiled data live and present the information on television, in the same was that weather forecasts are displayed. This could help the public to react calmly to an outbreak and take personal measures quickly to prevent spread of an infection.

Advantageously, the embodiment of FIG. 4 wherein each clinical symptom is monitored individually is also useful for alerting medical inventories for medications pertaining to each clinical symptom. Even when there is no major infection outbreak, it is possible that an occasional moderate increase in several diseases that have one or two common clinical symptoms could add up to a sudden and significant increase in demand for medications for those common clinical symptoms. Thus, monitoring each clinical symptom on its own can help the medical inventories to anticipate demand of any particular medications, even when there is no epidemic of a single disease.

1. A system for anticipating an epidemic, comprising
a host computer;
a plurality client computers having an interface for users to record clinical symptoms of patients;
the plurality of client computers having a communication link to the host computer;
the plurality of client computers each containing a set of rules;
the set of rules indicating at least one clinical symptom;
when the clinical symptoms of a patient is recorded into one of the plurality of client computers, the one of the plurality of client computers compares the clinical symptoms of the patient with the at least one clinical symptom in the set of rules;
if clinical symptom of the patient matches the at least one clinical symptom in the set of rules, data on the condition of patient is sent to the host computer; wherein
the host computer compiles the data on the condition of patients from the plurality of client computers.

2. A system for anticipating an epidemic as claimed in claim 1, wherein
the plurality of client computers is capable of polling the host computer at pre-determined intervals to download an updated set of rules.

3. A system for anticipating an epidemic, comprising
a host computer,
a plurality client computers having an interface for users to record clinical symptoms of patients,
the plurality of client computers having a communication link to the host computer to upload the records of clinical symptoms of patients to the host computer,
the host computer storing a predetermined threshold value,
the host computer having capability for identifying at least one of the clinical symptoms with an occurrence above the threshold value,
the host computer having a communication link to the client computers for triggering an alert in the client computers to the at least one clinical symptoms with an occurrence above the threshold value.

4. A system for anticipating an epidemic as claimed in claim 3, wherein,
the threshold value is an alert-frequency.

5. A system for anticipating an epidemic as claimed in claim 3, wherein,
the threshold value is a percentage based on historical data.

6. A system for anticipating an epidemic as claimed in claim 3, wherein,
the threshold value is a pre-determined rate of increase of the frequency of occurrence.

7. A system for anticipating an epidemic as claimed in claim 3, wherein
the clinical symptoms are monitored for specific combinations of the clinical symptoms in each patient.

8. A method of anticipating an epidemic, comprising the steps of
recording clinical symptoms of patients at interface provided in a plurality of client computers,
uploading the records of clinical symptoms of patients to a host computer,
compiling the records of clinical symptoms of patients to the host computer,
identifying at least one clinical symptom from among the records of clinical symptoms that have a number of occurrences over a pre-determined threshold,
triggering an alert in the client computers to the at least one clinical symptom.

9. A method of anticipating an epidemic as claimed in claim 8, wherein the step of
identifying at least one clinical symptom from among the records of clinical symptoms comprises
identifying a combination of clinical symptoms from among each patient's record, and
the threshold value is pre-determined for the combination of clinical symptoms.

10. A method of anticipating an epidemic as claimed in claim 8, wherein, the threshold value is an alert-frequency.

11. A method of anticipating an epidemic as claimed in claim 8, wherein, the threshold value is a percentage based on historical data.

12. A method of anticipating an epidemic as claimed in claim 8, wherein, the threshold value is a pre-determined rate of increase of the frequency of occurrence.

13. A system for anticipating an epidemic as claimed in claim 4, wherein the clinical symptoms are monitored for specific combinations of the clinical symptoms in each patient.

14. A system for anticipating an epidemic as claimed in claim 5, wherein the clinical symptoms are monitored for specific combinations of the clinical symptoms in each patient.

15. A system for anticipating an epidemic as claimed in claim 6, wherein the clinical symptoms are monitored for specific combinations of the clinical symptoms in each patient.

16. A method of anticipating an epidemic as claimed in claim 9, wherein, the threshold value is an alert-frequency.

17. A method of anticipating an epidemic as claimed in claim 9, wherein, the threshold value is a percentage based on historical data.

18. A method of anticipating an epidemic as claimed in claim 9, wherein, the threshold value is a pre-determined rate of increase of the frequency of occurrence.
